(19) United States
(12) Patent Application Publication
(10) Pub. No.: US 2016/0154594 A1
(43) Pub. Date: Jun. 2, 2016

(54) METHOD FOR MANAGING ADDRESS MAP FOR FAST OPEN OPERATION AND MEMORY SYSTEM

(71) Applicant: Samsung Electronics Co., Ltd., Suwon-si (KR)

(72) Inventor: Nam Wook KANG, Hwaseong-si (KR)

(21) Appl. No.: 14/946,135

(22) Filed: Nov. 19, 2015

(30) Foreign Application Priority Data
Nov. 27, 2014 (KR) 10-2014-0167765

(51) Int. Cl. G06F 3/06; G06F 12/02

(52) U.S. Cl. CPC G06F 3/0619; G06F 12/0246; G06F 3/0688; G06F 3/0659; G06F 3/0625; G06F 2212/7201

(57) ABSTRACT

Provided is a method for managing an address map for fast open in a memory system. Mapping blocks including metadata storing mapping information for constructing an address mapping table are differentially handled. The differentially handling mapping blocks includes differentiating the mapping blocks into a first group of mapping blocks and a second group of mapping blocks according to a journal management manner. The first group of mapping blocks are opened ahead of the second group of mapping blocks during power-on of the memory system after a power-off of the memory system.

### CROSS-REFERENCE TO RELATED APPLICATIONS

This US non-provisional patent application claims priority under 35 USC §119 to Korean Patent Application No. 10-2014-0167765, filed on Nov. 27, 2014, the entirety of which is hereby incorporated by reference.

### BACKGROUND

The present disclosure relates generally to storage systems and, more particularly, to methods for managing an address map and/or a memory system.

In general, semiconductor memory devices may be classified into volatile memory devices such as DRAM and SRAM and nonvolatile memory devices such as EEPROM, FRAM, PRAM, MRAM, and flash memory.

Volatile memory devices lose their stored data when their power supplies are interrupted, while nonvolatile memory device retain their stored data even when their power supplies are interrupted. Flash memory has characteristics such as high programming speed, low consumption of power, and large capacity data storage. Therefore, a memory system including a flash memory has been widely used as a data storage medium.

A typical flash memory device stores bit information by injecting charges into a conductive floating gate isolated by an insulation layer. A charge-trap flash (CTF) memory structure uses an insulation layer such as Si₃N₄, Al₂O₃, HfAlO, and HfSiO as a charge storage layer instead of a conventional conductive floating gate.

A charge-trap flash memory device may also be applied to a flash memory device having a three-dimensional structure (3D flash memory device).

A booting procedure of a memory system may be used during power-on of the memory system. In the booting procedure, a map open operation is performed to reconstruct an address mapping table by loading mapping blocks to a buffer memory.

### SUMMARY

Example embodiments of inventive concepts provide a method for managing an address map for fast open in a memory system. In example embodiments, the method may include differentially handling mapping blocks including metadata storing mapping information for constructing an address mapping table. The differentially handling mapping blocks includes differentiating the mapping blocks into a first group of mapping blocks and a second group of mapping blocks according to a journal management manner, and opening the first group of mapping blocks ahead of the second group of mapping blocks during power-on of the memory system after power-off of the memory system.

In example embodiments, the differentially handling mapping blocks may include managing the first group of mapping blocks so they do not have journal data. In example embodiments, the differentially handling mapping blocks may include designating the first group of mapping blocks as mapping blocks for fast open by logging logical block addresses within a set time after the power-on or designating the first group of mapping blocks as mapping blocks for fast open based on a command received from a host after the power-on.

In example embodiments, the differentially handling the mapping blocks may be continuously maintained during a runtime interval of the memory system.

In example embodiments, the differentially handling mapping blocks may include storing a smaller size of journal data in the first group of mapping blocks than an amount of journal data in each of the second group of mapping blocks.

In example embodiments, the differentially handling mapping blocks may include designating the first group of mapping blocks as mapping blocks for fast open by logging logical block addresses accessed within set time after the power-on.

In example embodiments, the differentially handling the mapping blocks may include designating the first group of mapping blocks as mapping blocks for fast open by logging logical block addresses accessed by the set number after the power-on.

In example embodiments, the differentially handling mapping blocks may include designating the first group of mapping blocks as mapping blocks for fast open by logging logical block addresses accessed by the set number after the power-on and selecting logical block addresses in the order of higher access frequency among the logged block addresses.

Example embodiments of inventive concepts provide a method for managing an address map for fast open in a memory system. In example embodiments, the method may include differentially handling mapping blocks that include metadata storing mapping information for constructing an address mapping table, the differentially handling mapping blocks including differentiating the mapping blocks into mapping blocks for fast open and normal mapping blocks having journal data; and loading the mapping blocks for fast open to a buffer memory ahead of the normal mapping block during power-on of the memory system after power-off of the memory system.

In example embodiments, the mapping blocks may be stored in a flash memory device, and the loading the mapping blocks for fast open may include using a memory controller to control the flash memory device.

In example embodiments, the flash memory device may include a plurality of memory blocks on a substrate. Each of the memory blocks may include a plurality of memory cells stacked in a direction perpendicular to the substrate.

In example embodiments, the differentially handling the mapping blocks may include managing the mapping blocks for fast open so they do not have journal data.

In example embodiments, the differentially handling the mapping blocks may include managing the mapping blocks for fast open so they have different journal data than journal data in the normal mapping blocks.

Example embodiments of inventive concepts provide a memory system. In example embodiments, the memory system may include a nonvolatile memory including a plurality of memory blocks each including a plurality of memory cells; and a memory controller including a fast open manger. The fast open manager may differentially handle mapping blocks including metadata storing mapping information for constructing an address mapping table into mapping blocks for fast open and normal mapping blocks having journal data and may load the mapping blocks for fast open to a buffer memory ahead of the normal mapping block during power-on of the memory system after power-off of the memory system.

In example embodiments, the memory cells may be multi-level cells stacked in a direction perpendicular to a substrate.

In example embodiments, the memory system may be a solid-state drive (SSD).

In example embodiments, the mapping blocks for fast open may not have log data corresponding to each of the mapping blocks.

In example embodiments, the mapping blocks for fast open may have logic data managed differently from logic data corresponding to each of the normal mapping blocks.

According to example embodiments of inventive concepts, a method of operating a memory unit includes: managing first and second mapping block groups of a nonvolatile memory device differently, the first and second mapping block groups each including metadata for constructing an address mapping table of the nonvolatile memory device, the managing the first and second mapping block groups differently including managing one of the first and second mapping block groups with journal data and managing an other of the first and second mapping block groups with no journal data or different journal data; and loading the one of the first and second mapping block groups ahead of the other of the first and second mapping block groups when power is supplied to the nonvolatile memory device after a power-off of the nonvolatile memory device.

In example embodiments, the memory the memory unit may be a memory controller, and the managing first and second mapping blocks differently may include using the memory controller to designate the first mapping block group for performing a fast open operation and managing the first mapping block group with no journal data or less journal data than an amount of journal data used to manage the second mapping block group.

In example embodiments, the memory unit may include a memory controller and the nonvolatile memory device. The managing first and second mapping blocks differently may include using the memory controller to designate the first mapping block group for performing a fast open operation and managing the first mapping block group with no journal data or less journal data than an amount of journal data used to manage the second mapping block group. The loading the one of the first and second mapping block groups ahead of the other of the first and second mapping block groups may include using the memory controller to load the meta data in the first mapping block group to a buffer area of the nonvolatile memory device.

In example embodiments, the method may further include constructing an address mapping table using information stored in the first and second mapping block groups. The loading the one of the first and second mapping block groups ahead of the other of the first and second mapping block groups may include using the memory controller to load the meta data and journal data in the second mapping block group to the buffer area after the meta data in the first mapping block group is loaded to the buffer area. The constructing the address mapping table may be performed after the meta data and journal data in the second mapping block group is loaded to the buffer area.

In example embodiments, the nonvolatile memory device may include a plurality of memory blocks on a substrate. Each of the memory blocks may include a plurality of memory strings. Each of the memory strings may include at least one memory cell that is located over another memory cell.

According to example embodiments of inventive concepts, speed of reconstructing an address mapping table is improved during a rebooting operation after power-off such as sudden power-off. As a result, system booting speed is improved.

### BRIEF DESCRIPTION OF THE DRAWINGS

The accompanying drawings are included to provide a further understanding of the disclosure, and are incorporated in and constitute a part of this specification. The drawings illustrate non-limiting embodiments of the disclosure and, together with the description, serve to explain principles of example embodiments of inventive concepts. Like reference characters refer to like parts throughout the different views. The drawings are not necessarily to scale, emphasis instead being placed upon illustrating principles of inventive concepts. In the drawings:

FIG. 1 is a block diagram of a memory system according to example embodiments of inventive concepts;

FIG. 2 is a block diagram of a memory controller in FIG. 1;

FIG. 3 is a block diagram of a software layer structure of the memory system in FIG. 1;

FIG. 4 is a block diagram of a memory device in FIG. 1;

FIG. 5 is a perspective view of a three-dimensional structure of a memory block in FIG. 4;

FIGS. 6 and 7 illustrate a triple flash translation layer in FIG. 3;

FIG. 8 shows an example of storing mapping information for constituting (and/or constructing) an address mapping table in the memory device in FIG. 1;

FIG. 9 illustrates a fast open operation according to example embodiments of inventive concepts;

FIG. 10 illustrates a normal open operation according to example embodiments of inventive concepts;

FIG. 11 is a flowchart summarizing a method for managing an address map for fast open according to example embodiments of inventive concepts;

FIG. 12 is a flowchart summarizing designation of mapping blocks for fast open according to example embodiments of inventive concepts;

FIG. 13 illustrates designation of mapping blocks for fast open based on time according to FIG. 12;

FIG. 14 illustrates designation of mapping blocks for fast open based on the access frequency according to FIG. 12;

FIG. 15 illustrates designation of mapping blocks for fast open by receiving a command according to FIG. 12;

FIG. 16 is a block diagram illustrating an example of applying a memory system according to example embodiments of inventive concepts to a flash-based memory system;

FIG. 17 is a block diagram illustrating an example of applying a memory card system according to example embodiments of inventive concepts to a memory card system;

FIG. 18 is a block diagram illustrating an example of applying a memory system according to example embodiments of inventive concepts to a solid-state drive (SSD) system;

FIG. 19 is a block diagram of an SSD controller in FIGS. 18; and

FIG. 20 is a block diagram of a memory system according to example embodiments of inventive concepts implemented in an electronic device.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

In example embodiments, a nonvolatile memory may be embodied to include a three dimensional (3D) memory array. The 3D memory array may be monolithically formed on a substrate (e.g., semiconductor substrate such as silicon, or semiconductor-on-insulator substrate). The 3D memory array may include two or more physical levels of memory cells having an active area disposed above the substrate and circuitry associated with the operation of those memory cells, whether such associated circuitry is above or within such substrate. The layers of each level of the array may be directly deposited on the layers of each underlying level of the array.

In example embodiments, the 3D memory array may include vertical NAND strings that are vertically oriented such that at least one memory cell is located over another memory cell. The at least one memory cell may comprise a charge trap layer. Each vertical NAND string further may include at least one select transistor located over memory cells, the at least one select transistor having the same structure with the memory cells and being formed monolithically together with the memory cells.

In example embodiments of inventive concepts, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

The following patent documents, which are hereby incorporated by reference in their entirety, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

Example embodiments will now be described more fully through the following example embodiments related to the accompanying drawings. However, the disclosure is not limited to the following embodiments but may be embodied in other forms.

Note that each embodiment that is herein explained may also include its complementary embodiment and the details of basic data access operations (including erase, program (or write), and read operations of a nonvolatile semiconductor memory such as a flash memory) and an internal function circuit to perform these basic operations are not described in order not to make the subject matter of the disclosure ambiguous.

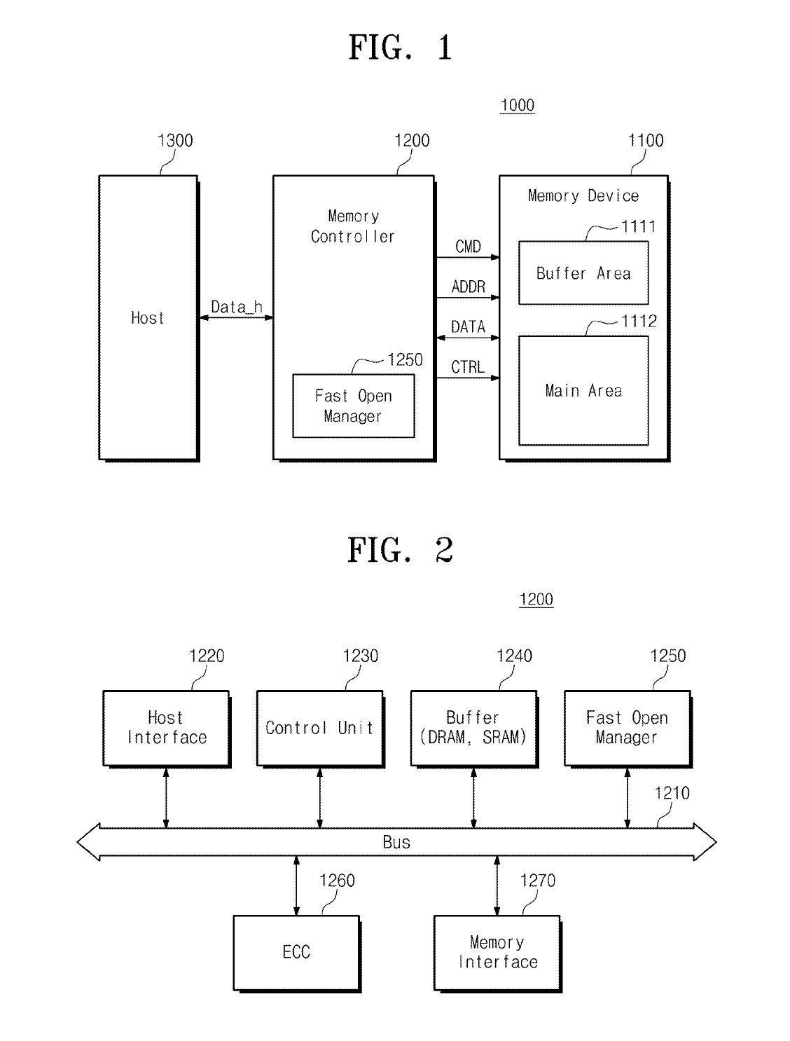

FIG. 1 is a block diagram of a memory system 1000 according to example embodiments of inventive concepts.

As illustrated in FIG. 1, the memory system 1000 includes a memory device 1100 and a memory controller 1200. The memory controller 1200 may be connected to a host 1300.

The memory device 1100 may be controlled by the memory controller 1200 and perform operations (e.g., read and write (program) operation, etc.) corresponding to a request of the memory controller 1200. The memory device 1100 may include a buffer area 1111 and a main area 1112. The memory device 1100 may be a nonvolatile memory device such as a NAND flash memory device. The memory device 1100 may be applied to not only a flash memory having a two-dimensional structure but also a flash memory having a three-dimensional structure (3D flash memory).

The buffer area 1111 may include a single-level cell to store one bit of data per cell. The main area 1112 may include a multi-level cell to store N bits of data per cell (N being an integer greater than or equal to 2). Alternatively, each of the buffer and main areas 1111 and 1112 may include a multi-level cell. In this case, only a least-significant bit (LSB) program operation may be performed such that the multi-level cell of the buffer area 1111 operates together with a single-level cell.

Meanwhile, each of the buffer and main areas 1111 and 1112 may include a single-level cell. The main area 111 and the buffer area 1111 may be implemented using a single memory device or implemented using separate memory devices. Data stored in the buffer area 1111 may be data provided from an external entity by a write request of the host 1300.

The memory controller 1200 is coupled between the memory device 1100 and the host 1300. The memory controller 1200 controls read and write operations on the memory device 1100 in response to a request of the host 1300. The memory controller 1200 may receive host data Data_h from the host 1300 and transmit data DATA to the memory device 1100. The memory controller 1200 may provide a command CMA, an address ADDR, data DATA, and a control signal CTRL to the memory device 1100.

The memory controller 1200 manages an address mapping table including information of a logical address (hereinafter referred to as “LA”) and a physical address (hereinafter referred to as “PA”).

The address mapping table may be created using metadata. The metadata may be data generated in the memory system 1000 to manage user data or the memory device 1100. The metadata may include mapping information used to translate a logical address to a physical address of the memory device 1100 and may include information to manage a memory space of the memory device 1100.

FIG. 2 is a block diagram of the memory controller 1200 in FIG. 1. As illustrated, the memory controller 1200 may include a system bus 1210, a host interface 1220, a control unit 1230, a buffer 1240 including a static random access memory (SRAM) or a dynamic random access memory (DRAM), a fast open manager 1250, an error correcting code (ECC) unit 1260, and a memory interface 1270.

When power is supplied to the memory system 1000, the memory controller 1200 generates a command and an address to be stored in a buffer memory 1240 by sequentially reading metadata that are stored in the memory device 1100 and divided into a plurality of groups. The memory controller 1200 controls the memory system 1000 such that metadata stored in the buffer memory 1240 is updated according to an operation where change of metadata occurs in the memory device 1100 and log entry information corresponding to the metadata change is generated and stored in the buffer memory 1240. The log entry information includes information used to restore change of metadata. In example embodiments, the logic entry information may include information on a type indicating an operation where change of metadata occurs and actual data to restore the change of metadata. The information on a type indicating an operation where change of metadata occurs may include information to define types of all operations capable of changing metadata of a write operation, a block designating operation, and a page copy operation. The actual data to restore the change of metadata may include a logical address, a previous physical address, and a new physical address. Log data, which is journal data, includes log entry information.

During power-on after an abnormal power-off state, the memory controller 1200 controls the operation of the memory system 1000 such that meta data is restored by reading sequentially effective data stored in the memory device 1100 and effective meta data in units of divided groups. The abnormal power-off means a state in which power supplied to the memory system 1000 is cut off while a power-off command is not received, e.g., sudden power-off.

The fast open manager 1250 controls a fast open operation within the memory controller 1200. The fast open manager 1250 may be implemented with software, hardware, or a combination of software and hardware. When the fast open manager 1250 is implemented with firmware that is a type of software, it may be included in a flash translation layer (FTL).

The fast open manager 1250 differentially handles mapping blocks storing mapping information for constituting (and/or constructing) an address mapping table to a first group of mapping blocks and a second group of mapping blocks for a runtime of the memory system 1000. The first group of mapping blocks and the second group of mapping blocks are differentiated according to a journal management manner.

The fast open manager 1250 may open the first group of mapping blocks during power-on of the memory system 1000 after power-off, ahead of the second group of mapping blocks.

When the first group of mapping blocks are designated as mapping blocks for fast open, the first group of mapping blocks do not include journal data corresponding to each of the mapping blocks. The journal data means log data. The journal data is data including information associated with storage or update of metadata.

When the first group of mapping blocks are designated as mapping blocks for fast open, the first group of mapping blocks may include journal data having a smaller size than journal data corresponding to each of the second group of mapping blocks.

The first group of mapping blocks may be designated as mapping blocks for fast open by logging logical block addresses accessed within set time after power-on.

The first group of mapping blocks may be designated as mapping blocks for fast open by logging logical block addresses by the set number after power-on.

The first group of mapping blocks may be designated as mapping blocks for fast open by receiving a command from a host after power-on.

The first group of mapping blocks may be designated as mapping blocks for fast open by logging accessed logical block addresses by the set number and selecting logical block addresses in the order of higher access frequency among the logged logical block addresses.

During a read operation, the memory controller 1200 reads data of memory cells connected to a wordline of a selected memory block in constant units. In this case, the data read in the constant units may be one-page data volume per wordline when memory cells are single-level cells (SLCs) and may be two-page data volume per wordline when memory cells are multi-level cells (MLCs).

In the memory system 1000 described with reference to FIG. 1, a fast open operation is performed to fast reconstruct an address mapping table during power-on after power-off such as sudden power-off. As a result, booting speed of the memory system 1000 is improved.

The system bus 1210 provides a channel between the host interface 1220, the control unit 1230, the buffer 1240, the fast open manager 1250, the ECC unit 1260, and the memory interface 1270.

The host interface 1220 may communicate with a host 1300 (see FIG. 1) through one of various interface protocols such as USB (Universal Serial Bus), PCI (peripheral component interconnection), PCI-E (PCI-express), ATA (Advanced Technology Attachment), Serial-ATA, Parallel-ATA, SCSI (small computer small interface), ESDI (enhanced small disk interface), IDE (Integrated Drive Electronics), and Firewire.

The control unit 1230 may receive host data Data_h and a command from the host 1300 and control the overall operation of the memory controller 1200.

The buffer 1240 may be used as at least one of a working memory, a cache memory, and a buffer memory for an internal operation of the memory controller 1200. The buffer 1240 used as a buffer memory may temporarily store data read from the memory device 1100 or data provided from the host 1300. The buffer 1240 may be used to drive firmware such as flash translation layer (FTL). The buffer memory 1240 may be implemented using DRAM, SRAM, MRAM, and PRAM.

As described in FIG. 1, the fast open manager 1250 performs a fast open operation according to example embodiments of inventive concepts in which some of the entire mapping blocks stored in the memory device 1100 are loaded first to the buffer 1240 to reconstruct an address mapping table during power-on.

The ECC unit 1260 performs an ECC encoding operation on the data received from the host 1300 to generate encoded data. The ECC unit 1260 performs an ECC decoding operation on the encoded data received from the memory device 1100 to generate original data. The ECC encoding and ECC decoding operations are collectively called an ECC operation.

The memory interface 1270 interfaces with the memory device 1100. For example, the memory interface 1270 may include a NAND flash interface or a vertical NAND (VNAND) interface. In example embodiments of inventive concepts, VNAND may mean a three-dimensional flash memory with high capacity.

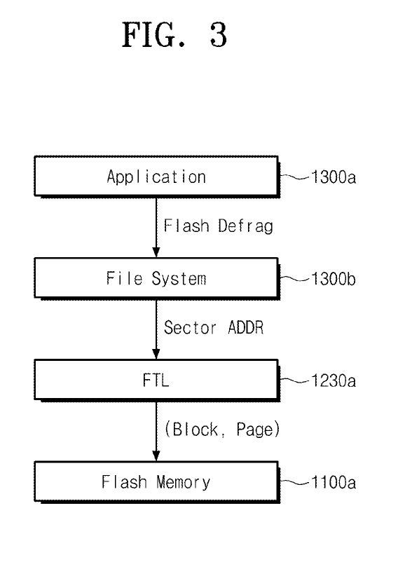

FIG. 3 is a block diagram of a software layer structure of the memory system 1000 in FIG. 1. As illustrated, the software layer structure of the memory system 1000 may include an application 1300a, a file system 1300b, a FTL 1230a, and a flash memory 1100a.

The file system 1300b may include not only systems used mainly in a floppy disk or a hard disk such as FAT (File Allocation Table), NTFS (New Technology File System), HPFS (High Performance File System), UFS (Unix File System), Ext2 (Second Extended File System), and Ext3 (Third Extended File System) but also file systems used only in a flash memory such as LFS, JFFS, YAFFS, and LogFS.

The FTL 1230a translates a sector number being a logical address to a block number or a page number being a physical address on a flash memory. The address translation of the FTL 1230a may be done through an address mapping table.

The FTL 1230a performs an emulation operation mimicking read/write operations conventionally directed to a hard disk, but instead performing read/program/erase operation(s) in the flash memory 1100a. Thus, from the viewpoint of higher level software/firmware components (e.g., the application 1300a or the file system 1300b), the read/program/erase operations resulting from operation of the FLT 1230a are “seen as” conventional read/write operations directed to a hard disk.

The file system 1300b receiving a logical block address LBA from the application 1300a may provide a sector address to the FTL 1230a. The Fit 1230a may translate a sector address or a logical address to a physical address and designate a block and a page of the flash memory 1100a.

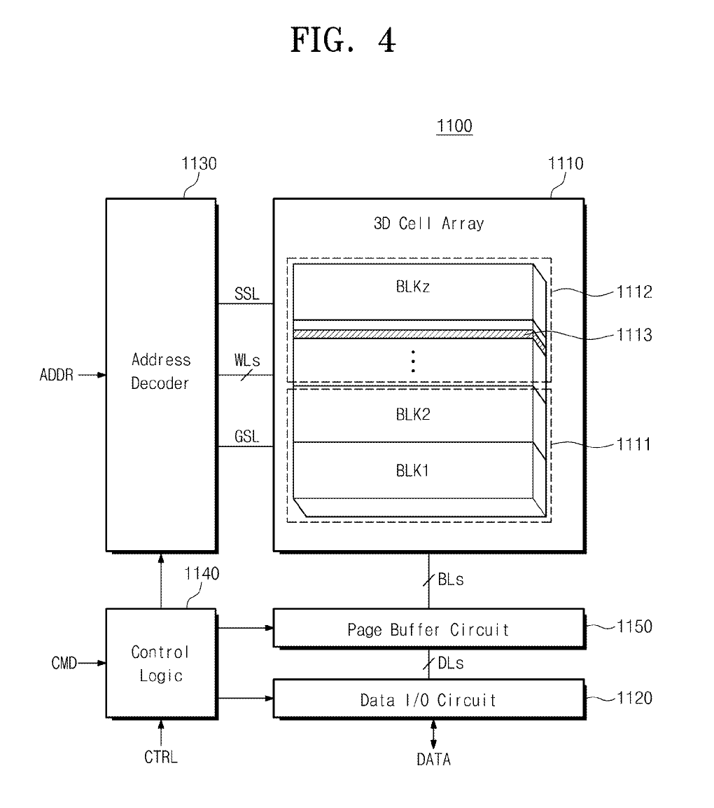

FIG. 4 is a block diagram of the memory device 1100 in FIG. 1. As illustrated, the memory device 1100 includes a three-dimensional (3D) memory cell array 1110, a data input/output (I/O) circuit 1120, an address decoder 1130, a page buffer circuit 1150, and a control logic 1140.

The 3D memory cell array 1110 includes a buffer area 1111 and a main area 1112. The 3D memory cell array 1110 includes a plurality of memory blocks BLK1 to BLKz. Each of the buffer and main areas 1111 and 1112 may include a plurality of memory blocks. Each of the memory blocks BLK1 to BLKz includes a plurality of pages 1113. In case of an SLC, a single page 1113 indicates a single wordline. In case of a 2-bit MLC, an LSB page and an MSB page correspond to a single wordline. Each memory block may indicate a three-dimensional structure (or vertical structure). In a memory block having a two-dimensional structure (or horizontal structure), memory cells are formed in a direction horizontal to a substrate. However, in a memory block having a three-dimensional structure, memory cells are formed in a direction perpendicular to a substrate. Each memory block constitutes an erase unit of the memory device 1100.

The data I/O circuit 1120 is connected to the 3D cell array 1110 through the page buffer circuit 1150 connected to a plurality of bitlines BLs. The data I/O circuit 1120 receives data DATA from an external entity or outputs data DATA read from the 3D memory cell array 1110 to an external entity.

The page buffer circuit 1150 functions as a write driver during a program (write) operation and functions as a data storage latch during a read operation.

The address decoder 1130 is connected to the 3D memory cell array 1110 through a plurality of wordlines WLs and selection lines GSL and SSL. The address decoder 1130 receives an address ADDR and selects a wordline.

The control logic 1140 controls program, read, and erase operations of the memory device 1110. For example, the control logic 1140 may control the address decoder 1130 to provide a program voltage to a selected wordline and control the data I/O circuit 1120 and the page buffer circuit 1150 to program data during a program operation.

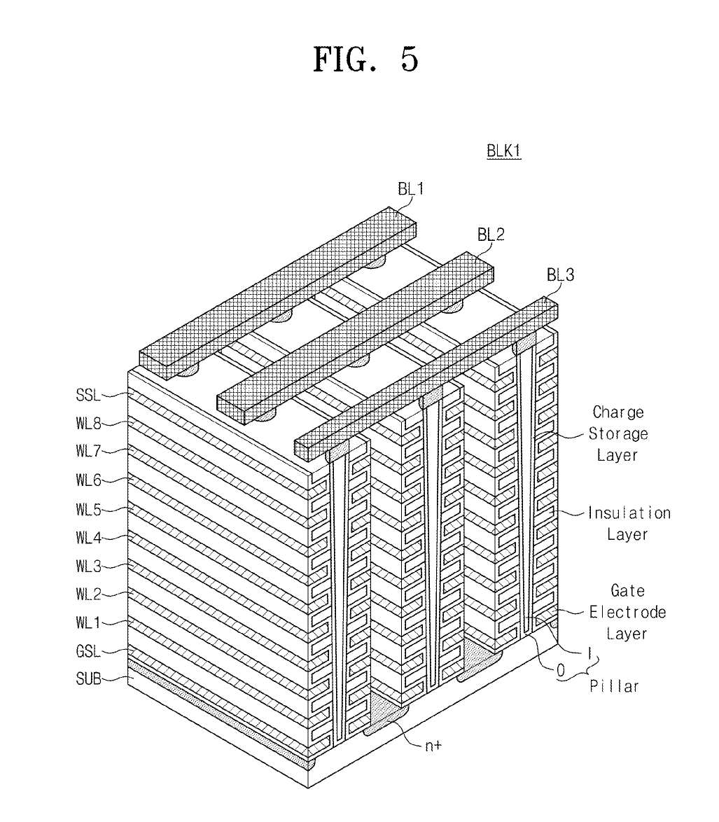

FIG. 5 is a perspective view of a three-dimensional structure of the memory block BLK1 in FIG. 4. As illustrated, the memory block BLK1 is formed in a direction perpendicular to a substrate SUB. An n+ doped region is formed on the substrate SUB. Gate electrode layers and insulation layers are alternately deposited on the substrate SUB. A charge storage layer may be disposed between the gate electrode layer and the insulation layer. The memory block BLK1 may define a charge-trap flash (CTF) memory structure, where a charge trap memory cell may be defined by a portion of the outside pillar O at the same height as a corresponding portions of the gate electrode layer and the charge storage layer. A typical flash memory device may include memory cells that store bit information by injecting charges into a conductive floating gate isolated by an insulation layer, but may have capacitive coupling between memory cells or between a memory cell and selection transistors. Thus, a conductive floating gate structure may physically limit high integration of some flash memory devices. The charge-trap flash (CTF) may overcome capacitive coupling between conductive floating gate because the charge-trap flash (CTF) includes the charge storage layer instead of a conductive floating gate. The charge storage layer may be formed of an insulation layer such as Si₃N₄, Al₂O₃, HfAlO, and HfSiO, but is not limited to those materials.

The gate electrode layer and the insulation layers are vertically patterned to form a V-shaped pillar. The pillar is connected to the substrate SUB through the gate electrode layer and the insulation layer. The outside (O) of the pillar may be made of a channel semiconductor, and the inside (I) thereof may be made of an insulating material such as silicon oxide.

Referring to FIG. 5, a gate electrode layer of the memory block BLK1 may be connected to a ground selection line GSL, a plurality of wordlines WL1 to WL8, and a string selection line SSL. A pillar of the memory block BLK1 may be connected to a plurality of bitlines BL1 to BL3. As shown in FIG. 5, a single memory block BLK1 includes two selection lines GSL and SSL and eight wordlines WL1 to WL8, and three bitlines BL1 to BL3. However, the numbers of selection lines GSL and SSL, wordlines WL, and bitlines BL included in the single memory block BLK1 are not limited thereto.

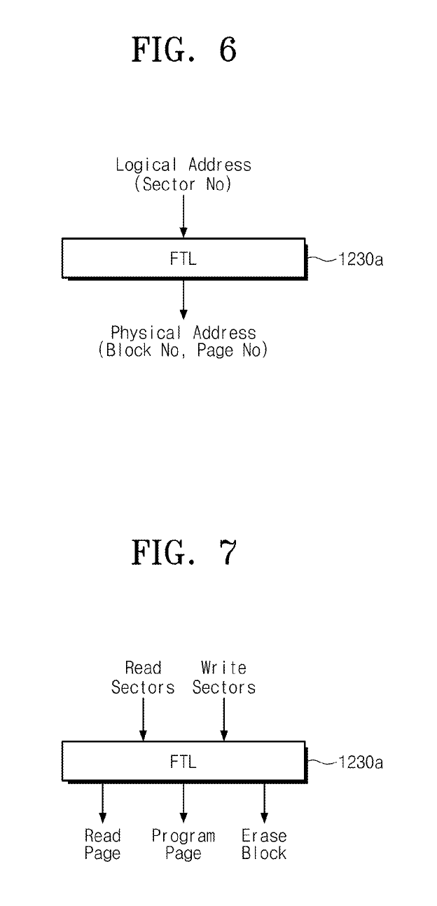

FIGS. 6 and 7 illustrate a triple flash translation layer in FIG. 3. As shown in FIG. 6, an FTL 1230a translates a sector number being a logical address to a block number or a page number being a physical address on a flash memory.

As shown in FIG. 7, the FTL 1230a performs an emulation operation mimicking read/write operations conventionally directed to a hard disk, but instead performing read/program/erase operation(s) in the flash memory 1100a. Thus, from the viewpoint of higher level software/firmware components (e.g., the application 1300a or the file system 1300b), the read/program/erase operations resulting from operation of the FLT 1230a are “seen as” conventional read/write operations directed to a hard disk.

The address translation of the FTL 1230a may be done through a virtual mapping table. There are two commonly used mapping methods: page mapping and block mapping. According to the page mapping, address translation is done in a page unit (e.g., 2 KB). According to the block mapping, address translation is done in a block unit (e.g., 1 MB).

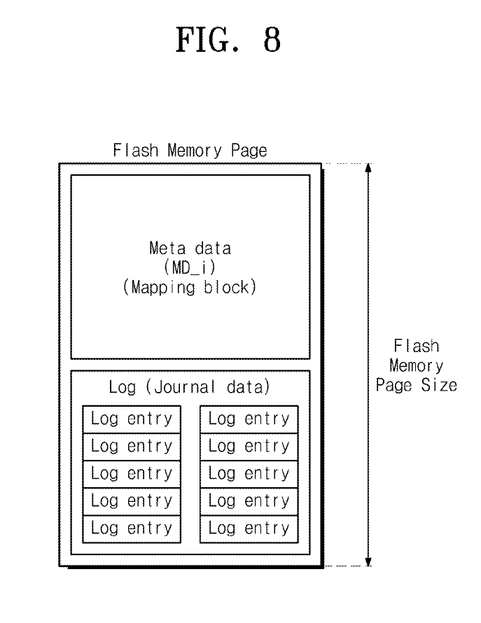

FIG. 8 shows an example of storing mapping information for constituting (and/or constructing) an address mapping table in the memory device 1100 in FIG. 1. If the memory device 1100 is a flash memory, metadata and log data (journal data) may be stored together in a single physical page of the flash memory. A log entry constituting the log data is used to update or restore the metadata. A division size of metadata and the number of log entries constituting journal data may be decided by the FTL 1230a. In example embodiments, metadata may be divided into a plurality of groups on the basis of a logical address. The divided metadata may be stored in different physical addresses of a flash memory according to the plurality of groups, respectively.

In example embodiments, a mapping block may be a mapping block including metadata. The mapping block including metadata may include or not include journal data. The metadata includes mapping information for constituting (and/or constructing) an address mapping table. The metadata may include information on a type indicating an operation where change of metadata occurs and actual data to restore the change of metadata.

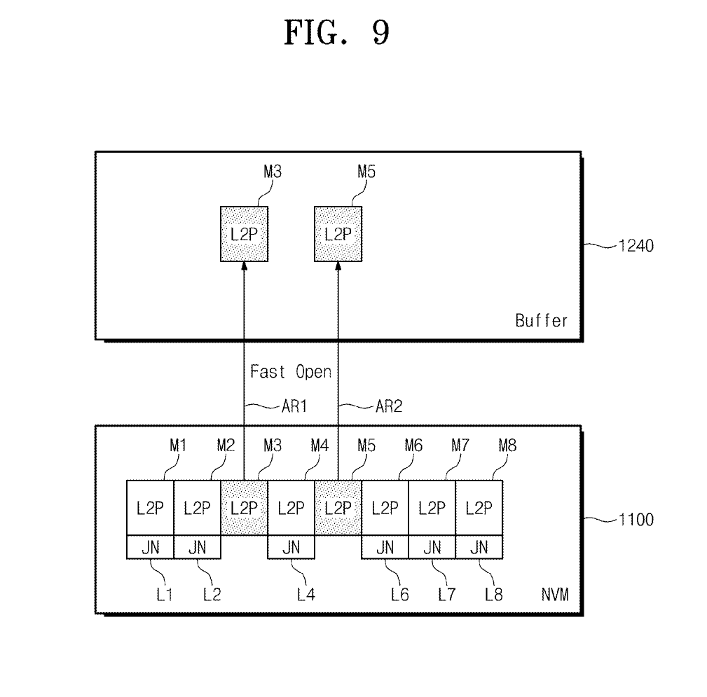

FIG. 9 illustrates a fast open operation according to example embodiments of inventive concepts. As data storage capacity of a memory system such as SSD increases, the number of physical memory blocks of a memory device such as NAND flash memory also increase. For this reason, since a size of an address mapping table of an FTL to manage addresses also increase, map open time used to load a mapping block including metadata and reconstruct the address mapping table during power-on increases. As high-capacity SSDs using a three-dimensional NAND flash emerge, there is a need to reduce increased map open time.

Since most open time of an SSD is used to reconstruct an address mapping table, map open time must be short for a fast response during power-on. However, when a special situation such as sudden power-off occurs, it takes long time to reconstruct a mapping table during power-on. That is, in case of a mapping algorithm using journal data, after the entire mapping blocks are loaded to a buffer memory, the journal data must be replayed to reconstruct an address mapping table. Therefore, map open time is long. Since most of the map open time is taken to update the mapping table through replay of the journal data when the address mapping table is reconstructed, there is a need for a method of decreasing the number of journal data.

According to example embodiments of inventive concepts, a method of performing a fast map open operation by decreasing the number of journal data is disclosed.

FIG. 9 illustrates a fast open operation according to example embodiments of inventive concepts. Referring to FIG. 9, among mapping blocks M1 to M8 stored in the memory device 1100, the mapping blocks M3 and M5 may be handled as mapping blocks for fast open during runtime of the memory system 1000. That is, mapping blocks including metadata storing mapping information for reconstructing the address mapping table are differentially handled as the mapping blocks M3 and M5 for the fast open and normal mapping blocks M1, M2, M4, M6, M7, and M8 having the journal data. In FIG. 9, L2P in the mapping blocks represents metadata storing a logical address to a physical address and JN represents journal data.

The mapping blocks M3 and M5 may be managed not to have journal data. Alternatively, the mapping blocks M3 and M5 may be managed to have journal data having a smaller size than journal data L1, L2, L4, L6, L7, and L8 in the normal mapping blocks M1, M2, M4, M6, M7, and M8.

During power-on after sudden power-off, the mapping blocks M3 and M5 are loaded first from the memory device 1100 to the buffer 1240 in FIG. 2 ahead of the normal mapping blocks M1, M2, M4, M6, M7, and M8 to perform the fast open operation, as indicated by arrows AR1 and AR2.

In example embodiments of inventive concepts, the fast open operation means an operation to reconstruct an address mapping table by loading only metadata to a buffer memory without journal data during power-on or an operation to reconstruct an address mapping table by loading differentiated journal data and metadata to a buffer memory. That is, the fast open operation may include both an operation to read a map without journal data and operations to read a map and replay journal data.

As described above, mapping blocks for fast open are loaded first to a buffer memory ahead of normal mapping blocks. Thus, a fast open operation is implemented to improve booting speed of a memory system.

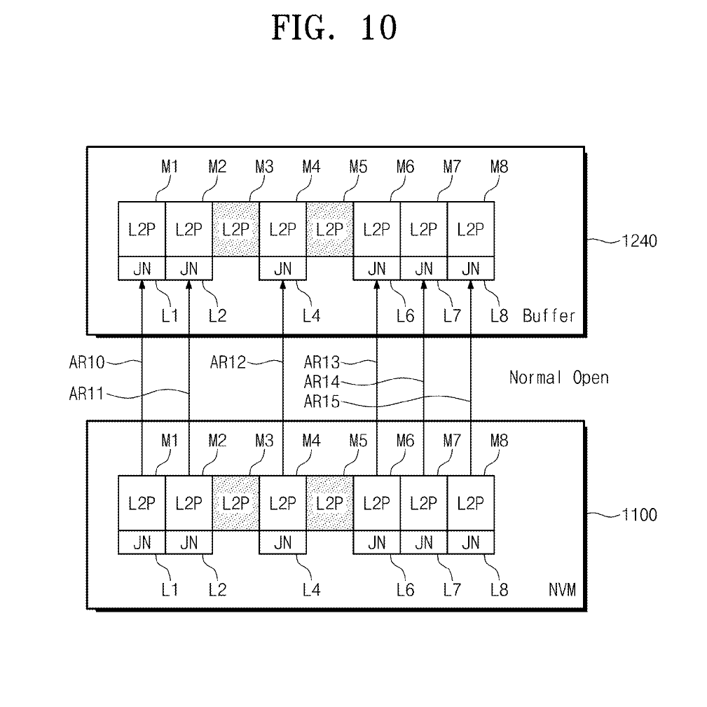

FIG. 10 illustrates a normal open operation according to example embodiments of inventive concepts. A normal open operation performed after the fast open operation in FIG. 9 is shown in FIG. 10.

In the normal open operation, normal mapping blocks M1, M2, M4, M6, M7, and M8 having respectively corresponding data L1, L2, L4, L6, L7, and L8 may be loaded from the memory device 1100 to the buffer 1240 in FIG. 2, as indicated by arrows AR10 to AR15.

Although the normal open operation is slower than a fast open operation, open speed is improved even when the mapping blocks M3 and M5 for fast open are loaded together during the normal open operation.

In example embodiments of inventive concepts, the normal open operation means a typical operation to reconstruct an address mapping table by loading metadata and journal data being log data to a buffer memory during power-on.

Although an example is described with reference to FIGS. 9-10, where mapping blocks M3 and M5 are handled as mapping blocks for fast open during the runtime of the memory system 1000, example embodiments are not limited thereto. Other memory blocks among the memory blocks M1 to M8 may alternatively be configured similar to M3 and M5 and handled as mapping blocks for fast open.

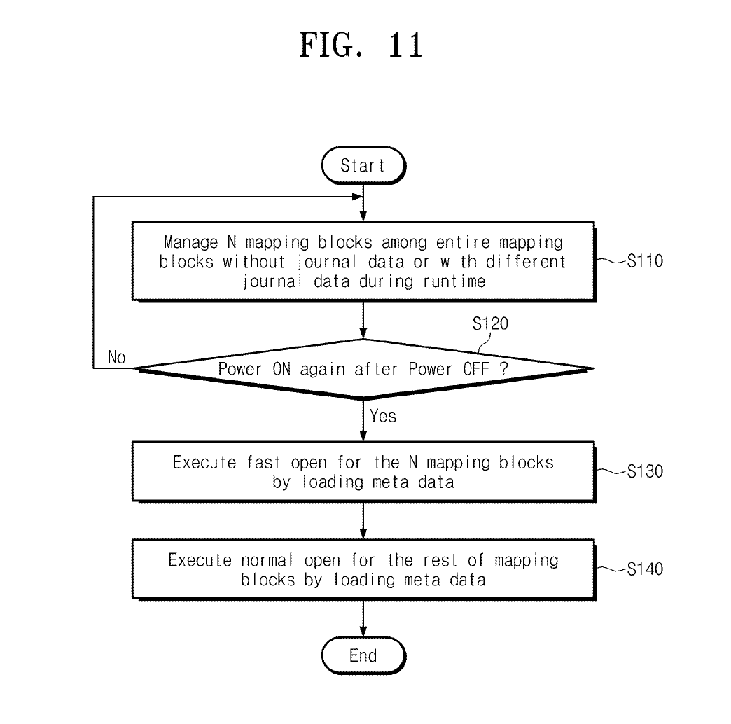

FIG. 11 is a flowchart summarizing a method for managing an address map for fast open according to example embodiments of inventive concepts. Referring to FIG. 11, operation S110 is performed during a runtime operation. The runtime operation means a memory operation prior to occurrence of sudden power-off. Among the entire mapping blocks, N mapping blocks are managed for fast open without journal data or with differentiated journal data (S110). N may be an integer that is greater than or equal to 1 and less than or equal to a total number of the entire mapping blocks (e.g., mapping blocks M1 to M8 in FIGS. 9-10). The N mapping blocks may correspond to desired (and/or alternatively predetermined) mapping blocks among the entire mapping blocks. That is, as described with reference to FIG. 9, the entire mapping blocks may be handled by dividing them into N mapping blocks for fast open (e.g., mapping blocks M3 and M5) and normal mapping blocks M1, M2, M4, M6, M7, and M8 having journal data. For ease of description, an example hereinafter is described where the N mapping blocks for fast open correspond to the mapping blocks M3 and M5. The mapping blocks M3 and M5 for fast open may be managed without journal data or may be managed with journal data having a smaller size than journal data L1, L2, L4, L6, L7, and L8 of the normal mapping blocks M1, M2, M4, M6, M7, and M8.

In operation S120, the memory controller (see FIG. 1) may check if a Power-on again after power-off such as sudden power-off occurred.

When the check result is the power-on again (S120), the memory system may execute a fast open operation (S130). The memory controller may control executing the fast open operation on the memory device. As described with reference to FIG. 9, among the entire mapping blocks, the mapping blocks M3 and M5 for fast open may be loaded first to a buffer memory to reconstruct an address mapping table. If the mapping table M3 and M5 for fast open are managed without journal data, a fast open operation is implemented by a map read operation to load metadata to the buffer memory. Meanwhile, if the mapping blocks M3 and M5 for fast open are managed with differentiated journal data, a fast open operation is implemented by a map read operation to load metadata into the buffer and an operation to replay journal data.

After execution of the fast open operation is completed, the flow proceeds to operation S140. As described with reference to FIG. 10, a normal open operation is executed (S140). The memory controller may control the memory device for executing the normal open operation.

During the normal open operation, the normal mapping blocks M1, M2, M4, M6, M7, and M8 are loaded from the memory device 1100 to the buffer 1240 in FIG. 2 and their corresponding journal data L1, L2, L4, L6, L7, and L8 are replayed to reconstruct an address mapping table.

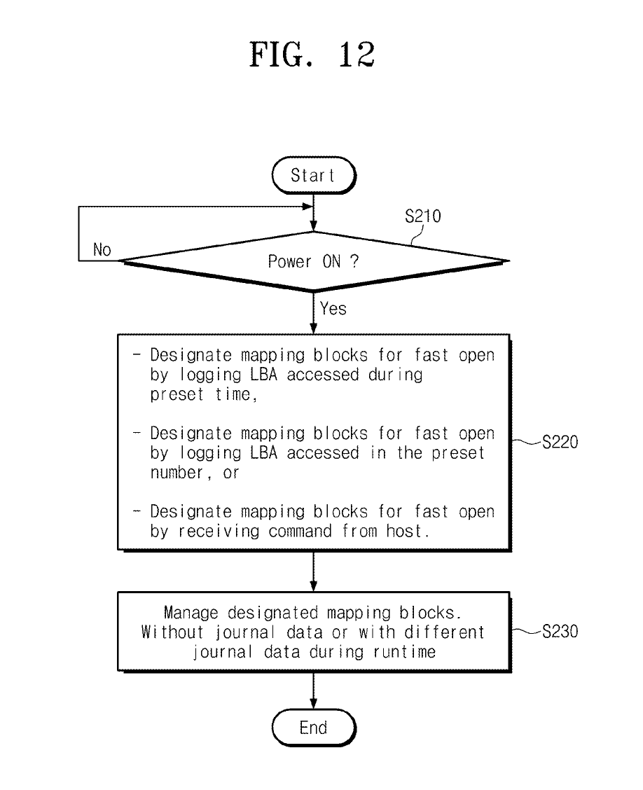

FIG. 12 is a flowchart summarizing designation of mapping blocks for fast open according to example embodiments of inventive concepts. In operation S210, Power-on is checked (S210). When a memory system is powered on, the memory system may designate a mapping block for fast open (S220).

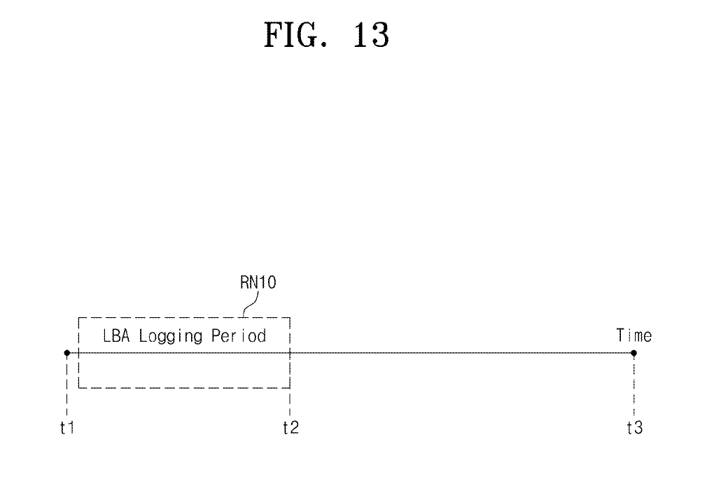

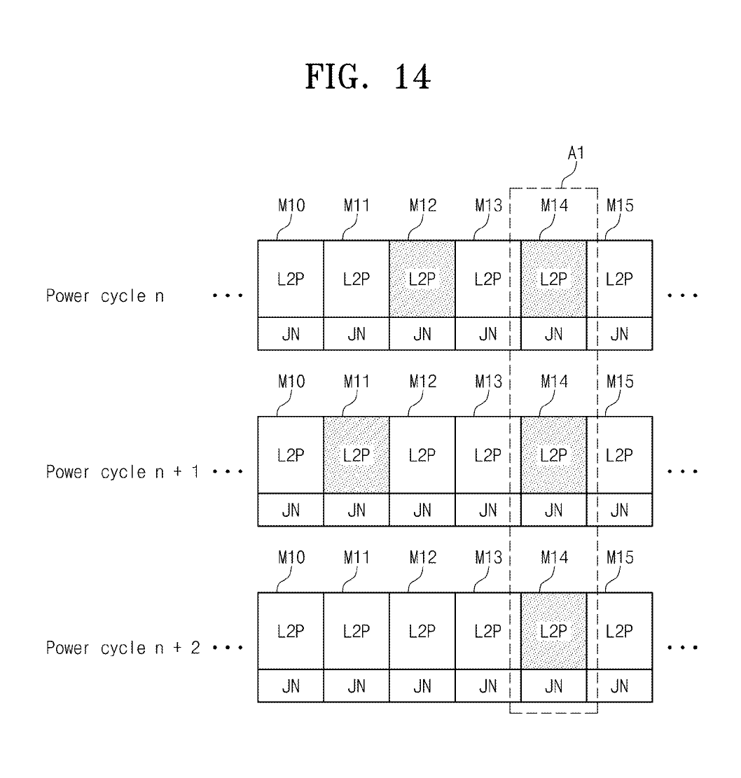

At operation S220, a first group of mapping blocks, e.g., the mapping blocks M3 and M5 in FIG. 9 may be designated as mapping blocks for fast open by logging logical block addresses accessed within desired (and/or alternatively predetermined) time after power-on, as shown in FIG. 13.

As another designation method, the mapping blocks M3 and M5 may be designated as mapping blocks for fast open by logging logical block addresses accessed by the set number after power-on.

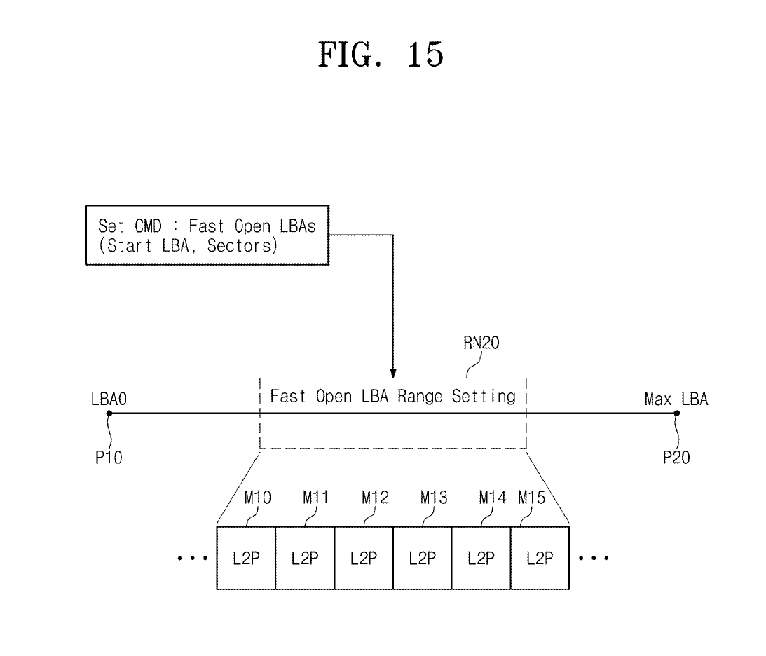

As another designation method, the mapping blocks M3 and M5 may be designated as mapping blocks for fast open by receiving a command from a host after power-on, as will be shown in FIG. 15.

As another designation method, the first group of mapping blocks, e.g., the mapping blocks M3 and M5 in FIG. 9 may be designated by mapping blocks for fast open by logging logical block addresses by the set number after power-on and selecting logical block addresses the logged logical block addresses in the order of higher access frequency, as will be shown in FIG. 14.

FIG. 13 illustrates designation of mapping blocks for fast open according to FIG. 12. In FIG. 13, a time point t1 on a time axis represents a power-on point. A time point t3 may mean a booting end point. When an LBA logged from a host for a time interval between the time point t1 and a time point t2 is checked, mapping blocks corresponding to the checked LBA are designated as mapping blocks for fast open. As a result, an interval of the reference numeral RN10 in FIG. 13 is an interval to designate mapping blocks for fast open.

FIG. 14 illustrates designation of mapping blocks for fast open based on the access frequency according to FIG. 12. FIG. 14 shows that after logical block addresses accessed by the set number after power-on are logged, the logged logical block addresses are selected in the order of higher access frequency. That is, mapping blocks of higher access frequency are set as mapping blocks according to a power cycle of the designated number, as indicated by a reference numeral A1. In case of FIG. 14, since the mapping block M14 is set as a mapping block of higher access frequency than the other mapping blocks M10,M11,M12,M13, and M15 throughout power cycles n, n+1, and n+2, the mapping block M14 is designated as one of the mapping blocks for fast open.

FIG. 15 illustrates designation of mapping blocks for fast open by receiving a command according to FIG. 12. In FIG. 15, an interval between P10 and P20 means the address range of an LBA. An address interval of the LBA is designated as a mapping block for fast open, as indicated by a reference number RN20. In this case, a command may include a start LBA and a sector. In FIG. 15, mapping blocks M10 to M15 are designated as mapping blocks for fast open by a command. However, this method is merely an example and other mapping blocks may be designated as mapping blocks for fast open.

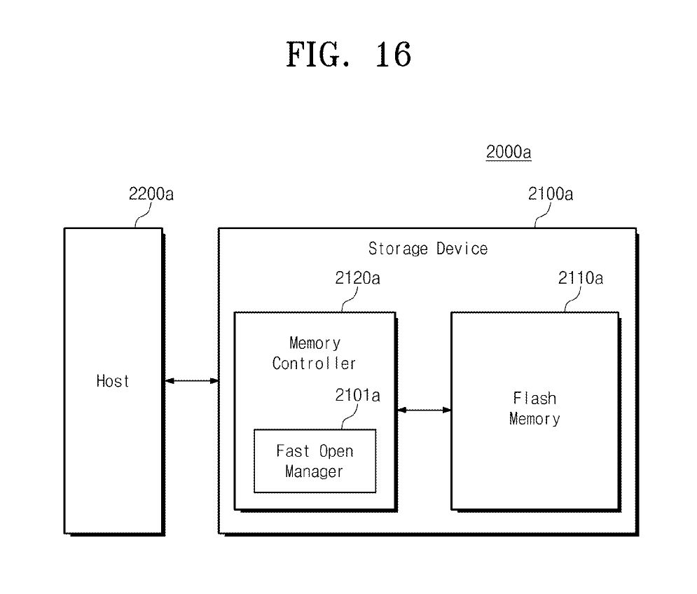

FIG. 16 is a block diagram illustrating an example of applying a memory system according to example embodiments of inventive concepts to a flash-based memory system 2000a. As illustrated, the memory system 2000a includes a storage device 2100a and a host 2200a. The storage device 2100a may include a flash memory 2110a and a memory controller 2120a.

The storage device 2100a may include a memory card (e.g., SD, MMC, etc.) or a removable portable storage device (e.g., USB memory, etc.). The storage device 2100a may be connected to the host 2200a to be used. The storage device 2100a transmits or receives data to or from the host 2200a via a host interface. The storage device 2100a may be supplied with power from the host 2200a to perform an internal operation.

In case of FIG. 16, the memory controller 2120a includes a fast open manager 2101a for fast open to control a fast open operation. Accordingly, since the fast open operation is performed first when an address mapping table is reconstructed after power-off such sudden power-off, system booting speed is improved.

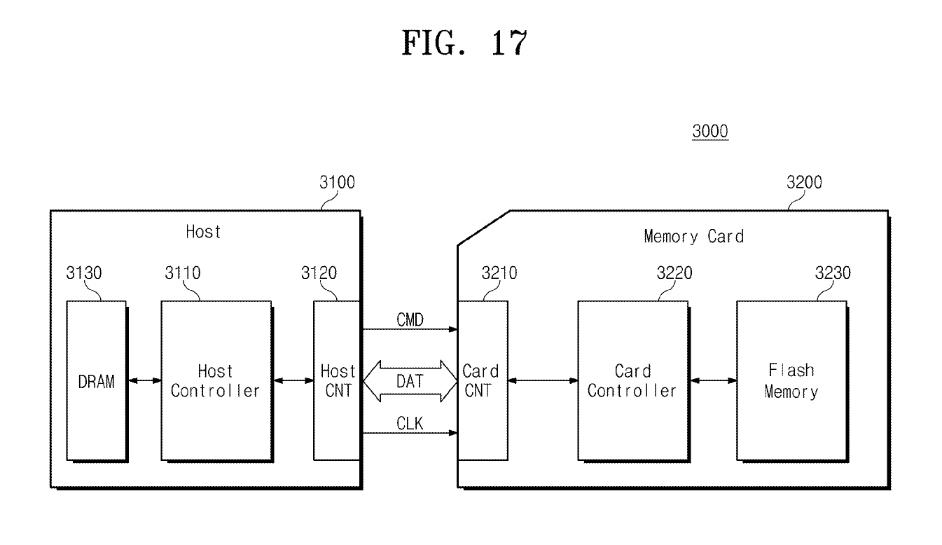

FIG. 17 is a block diagram illustrating an example of applying a memory card system 3000 according to example embodiments of inventive concepts to a memory card system. As illustrated, the memory card system 3000 may include a host 3100 and a memory card 3200. The host 3100 may include a host controller 3110, a host connection unit 3120, and a DRAM 3130.

The host 3100 may write data in the memory card 3200 and read data from the memory card 3200. The host controller 3110 may send a command (e.g., a write command), a clock signal CLK generated from a clock generator (not shown) in the host 3100, and data to the memory card 3200 via the host connection unit 3120. The DRAM 3130 may be a main memory of the host 3100.

The memory card 3200 may include a card connection unit 3210, a card controller 3220, and a flash memory 3230. The card controller 3220 may store data in the flash memory 3230 in response to a command input via the card connection unit 3210. The data may be stored in synchronization with a clock signal generated in the card controller 3220. The flash memory 3230 may store data transferred from the host 3100. For example, in a case where the host 3100 is a digital camera, the flash memory 3230 may store image data.

The memory card system 3000 may be, for example, an MMC card, an SD card, a multiuse card, a micro SD card, a memory stick, a compact SD card, an ID card, a PCMCIA card, an SSD card, a chipcard, a smartcard, a USB card or the like.

The memory card system 300 may include a fast open manager in the card controller 3220. As described above, due to an operation of the fast open manager, speed of reconstructing an address mapping table is improved in a rebooting operation after power-off such as sudden power-off. Thus, booting speed of the memory card system 3000 is improved.

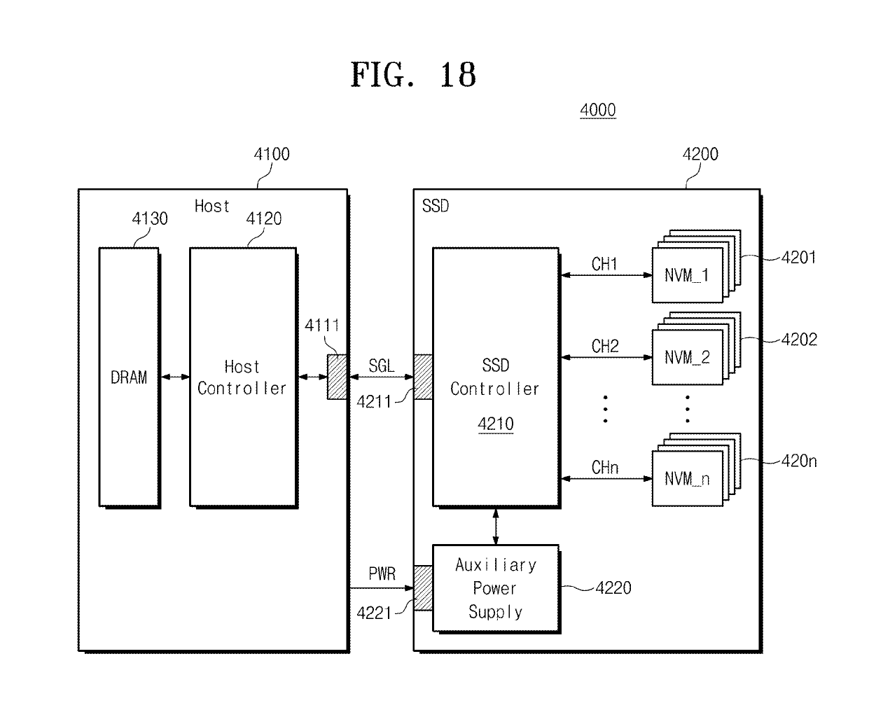

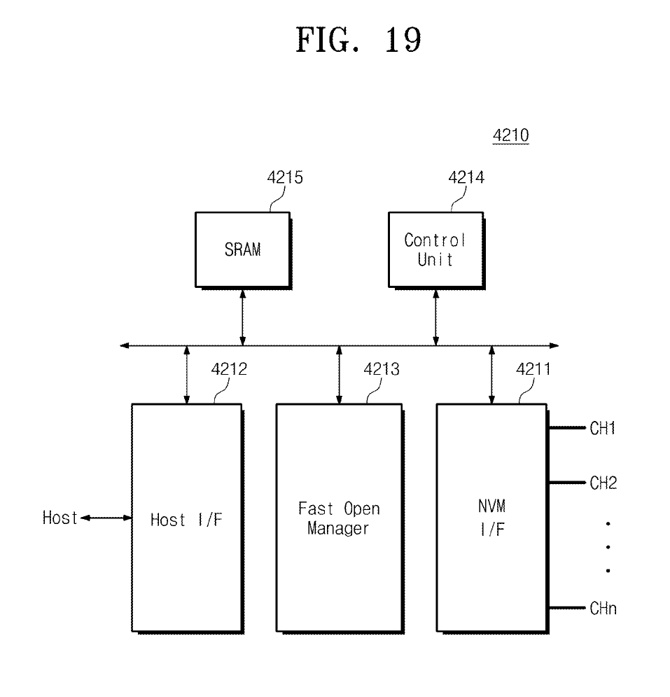

FIG. 18 is a block diagram illustrating an example of applying a memory system according to example embodiments of inventive concepts to a solid-state drive (SSD) system 4000. As illustrated, the SSD system 4000 includes a host 4100 and an SSD 4200. The host 4100 may include a host interface 4111, a host controller 4120, and a DRAM 4130.

The host 4100 may write data in the SSD 4200 or read data from the SSD 4200. The host controller 4120 may transfer signals SGL such as a command, an address, a control signal, and the like to the SSD 4200 via the host interface 4111. The DRAM 4130 may be a main memory of the host 4100.

The SSD 4200 may exchange signals SGL with the host 4100 via the host interface 4211 and may be supplied with power via a power connector 4221. The SSD 4200 may include a plurality of nonvolatile memories 4201 to 420n, an SSD controller 4210, and an auxiliary power supply 4220. The nonvolatile memories 4201 to 420n may be implemented using not only a flash memory but also PRAM, MRAM, ReRAM or the like.

The plurality of nonvolatile memories 4201 to 420n may be used as a storage medium of the SSD 4200. The plurality of nonvolatile memories 4201 to 420n may be connected with the SSD controller 4210 via a plurality of channels CH1 to CHn. A single channel may be connected to one or more nonvolatile memories. The nonvolatile memories connected to the single channel may be connected to the same data bus.

The nonvolatile memory may be packaged into a single package. For example, the DRAM 3500 may be packaged using one of various types of packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), and Wafer-Level Processed Stack Package (WSP).

The SSD controller 4210 may exchange signals SGL with the host 4100 via the host interface 4211. The signals SGL may include a command, an address, data, and the like. The SSD controller 4210 may be configured to write or read data into or from a corresponding nonvolatile memory according to a command of the host 4100. The SSD controller 4210 may have the same configuration as shown in FIG. 19.

The auxiliary power supply 4220 may be connected to the host 4100 via the power connector 4221. The auxiliary power supply 4220 may be charged by power PWR from the host 4100. The auxiliary power supply 4220 may be disposed inside or outside the SSD 4200. For example, the auxiliary power supply 4220 may be disposed on a mainboard to supply auxiliary power to the SSD 4200.

Since the SSD controller 4210 includes a fast open manager according to example embodiments of inventive concepts, speed of reconstructing an address mapping table is improved during a rebooting operation after sudden power-off.

FIG. 19 is a block diagram of the SSD controller 4210 in FIG. 18. As illustrated, the SSD controller 4210 includes an NVM interface 4211, a host interface 4212, a fast open manger 4213, a control unit 4214, and an SRAM 4215.

The NVM interface 4211 may scatter data transferred from a main memory of a host 4100 to channels CH1 to CHn, respectively. The NVM interface 4211 may transfer data read from nonvolatile memories 4201 to 420n to the host 4100 via the host interface 4212.

The host interface 4212 may provide an interface with an SSD 4200 according to the protocol of the host 4100. The host interface 4212 may communicate with the host 4100 using USB (Universal Serial Bus), SCSI (Small Computer System Interface), PCI express, ATA, PATA (Parallel ATA), SATA (Serial ATA), SAS (Serial Attached SCSI) or the like. The host interface 4212 may perform a disk emulation function which enables the host 4100 to recognize the SSD 4200 as a hard disk drive (HDD).

The fast open manager 4213 fast loads mapping blocks stored in the nonvolatile memories 4201 to 420n to a buffer memory during rebooting to fast reconstruct an address mapping table, as described above.

The control unit 4214 may analyze and process a signal SGL input from the host 4100. The control unit 4214 may control the host 4100 via the host interface 4212 or the nonvolatile memories 4201 to 420n via the NVM interface 4211. The control unit 4214 may control the nonvolatile memories 4201 to 420n using firmware for driving the SSD 4200. The functions of the fast open manager 4213 may be integrated into the control unit 4214.

The SRAM 4215 may function as a buffer memory and may be used to drive software that efficiently manages the nonvolatile memories 4201 to 420n. The SRAM 4215 may store metadata input from a main memory of the host 4100 or cache data. During a sudden power-off operation, metadata or cache data stored in the SRAM 4215 may be stored in the nonvolatile memories 4201 to 420n using an auxiliary power supply 4220.

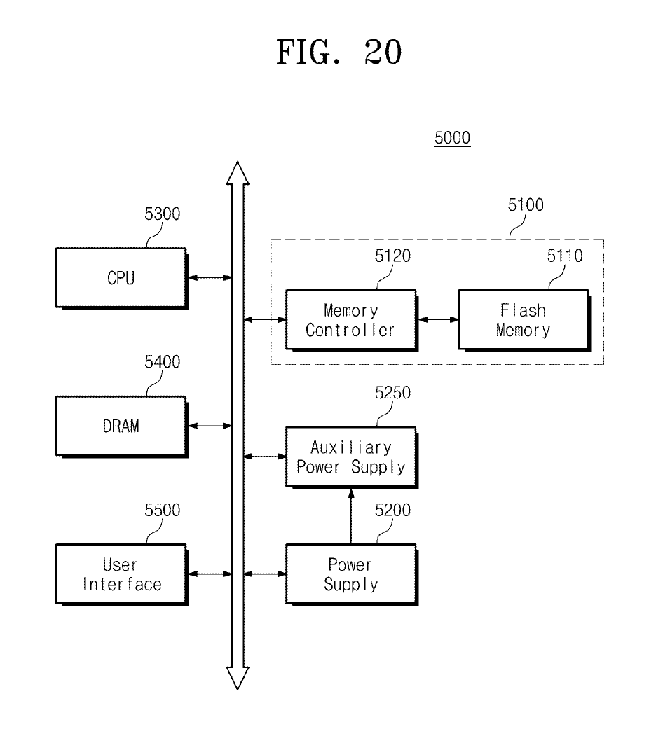

FIG. 20 is a block diagram of a memory system according to example embodiments of inventive concepts implemented in an electronic device 5000. The electronic device 5000 may be provided as one of a computer, an ultra-mobile PC (UMPC), a workstation, a netbook, a personal digital assistant (PDA), a portable computer, a web tablet, a wireless phone, a mobile phone, a smart phone, an e-book, a portable multimedia player (PMP), a portable game device, a navigation device, a black box, a digital camera, a digital multimedia broadcasting (DMB) player, a three-dimensional television, a smart television, a digital audio recorder, a digital audio player, a digital picture recorder, a digital picture player, a digital video recorder, and a digital video player, a device capable of transmitting/receiving information in wireless environment, one of various electronic devices constituting a home network, an RFID device or one of various elements constituting a computing system.

As illustrated in FIG. 20, the electronic device 5000 may include a memory system 5100, a power supply 5200, an auxiliary power supply 5250, a central processing unit (CPU) 5300, a DRAM 5400, and a user interface 5500. The memory system 5100 may include a flash memory 5110 and a memory controller 5120. The memory system 5100 may be embedded within the electronic device 5000.

The memory controller 5120 may include a fast open manage to perform a fast open operation when an address mapping table is reconstructed, as described above. Accordingly, since the electronic device 5000 has high booting speed after sudden power-off, its performance is enhanced.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A method for managing an address map for fast open in a memory system, the method comprising:
differentially handling mapping blocks that include metadata storing mapping information for constructing an address mapping table,
the differentially handling mapping blocks including differentiating the mapping blocks into a first group of mapping blocks and a second group of mapping blocks according to a journal management manner; and
opening the first group of mapping blocks ahead of the second group of mapping blocks during power-on of the memory system after power-off of the memory system.

2. The method as set forth in claim 1, wherein the differentially handling mapping blocks includes managing the first group of mapping blocks so they do not have journal data.

3. The method as set forth in claim 2, wherein the differentially handling mapping blocks includes designating the first group of mapping blocks as mapping blocks for fast open by logging logical block addresses accessed within a set time after the power-on.

4. The method as set forth in claim 2, wherein the differentially handling mapping blocks includes designating the first group of mapping blocks as mapping blocks for fast open based on a command received from a host after the power-on.

5. The method as set forth in claim 1, wherein the differentially handling the mapping blocks is continuously maintained during a runtime interval of the memory system.

6. The method as set forth in claim 1, wherein the differentially handling mapping blocks includes designating the first group of mapping blocks as mapping blocks for fast open by logging logical block addresses accessed by the set number after the power-on.

7. The method as set forth in claim 1, wherein the differentially handling mapping blocks includes storing a smaller size of journal data in the first group of mapping blocks than an amount of journal data in each of the second group of mapping blocks.

8. The method as set forth in claim 7, wherein the differentially handling mapping blocks includes designating the first group mapping blocks as mapping blocks for fast open by logging logical block addresses accessed within a set time after the power-on.

9. The method as set forth in claim 7, wherein the differentially handling mapping blocks includes designating the first group of mapping blocks as mapping blocks for fast open by logging logical block addresses accessed by a set number after the power-on.

10. The method as set forth in claim 7, wherein the differentially handling mapping blocks includes designating the first group of mapping blocks as mapping blocks for fast open by logging logical block addresses accessed by the set number after the power-on and selecting logical block addresses in the order of higher access frequency among the logged block addresses.

11. A method for managing an address map for fast open in a memory system, the method comprising:
differentially handling mapping blocks that include metadata storing mapping information for constructing an address mapping table,
the differentially handling mapping blocks including differentiating the mapping blocks into mapping blocks for fast open and normal mapping blocks having journal data; and
loading the mapping blocks for fast open to a buffer memory ahead of the normal mapping block during power-on of the memory system after power-off of the memory system.

12. The method as set forth in claim 11, wherein
the mapping blocks are stored in a flash memory device, and
the loading the mapping blocks for fast open includes using a memory controller to control the flash memory device.

13. The method as set forth in claim 12, wherein
the flash memory device includes a plurality of memory blocks on a substrate, and
each of the memory blocks includes a plurality of memory cells stacked in a direction perpendicular to the substrate.

14. The method as set forth in claim 11, wherein the differentially handling mapping blocks includes managing the mapping blocks for fast open so they do not have journal data.

15. The method as set forth in claim 11, wherein the differentially handling mapping blocks includes managing the mapping blocks for fast open so they have different journal data than journal data in the normal mapping blocks.

16. A method of operating a memory unit, the method comprising:
managing first and second mapping block groups of a nonvolatile memory device differently,
the first and second mapping block groups each including metadata for constructing an address mapping table of the nonvolatile memory device,
the managing the first and second mapping block groups differently including managing one of the first and second mapping block groups with journal data and managing an other of the first and second mapping block groups with no journal data or different journal data; and
loading the one of the first and second mapping block groups ahead of the other of the first and second mapping block groups when power is supplied to the nonvolatile memory device after a power-off of the nonvolatile memory device.

17. The method as set forth in claim 16, wherein
the memory unit is a memory controller, and
the managing first and second mapping blocks differently includes using the memory controller to designate the first mapping block group for performing a fast open operation and managing the first mapping block group with no journal data or less journal data than an amount of journal data used to manage the second mapping block group.

18. The method as set forth in claim 16, wherein
the memory unit includes a memory controller and the nonvolatile memory device,
the managing first and second mapping blocks differently includes using the memory controller to designate the first mapping block group for performing a fast open operation and managing the first mapping block group with no journal data or less journal data than an amount of journal data used to manage the second mapping block group, and
the loading the one of the first and second mapping block groups ahead of the other of the first and second mapping block groups includes using the memory controller to load the meta data in the first mapping block group to a buffer area of the nonvolatile memory device.

19. The method as set forth in claim 18, further comprising:
constructing an address mapping table using information stored in the first and second mapping block groups, wherein
the loading the one of the first and second mapping block groups ahead of the other of the first and second mapping block groups includes using the memory controller to load the meta data and journal data in the second mapping block group to the buffer area after the meta data in the first mapping block group is loaded to the buffer area, and
the constructing the address mapping table is performed after the meta data and journal data in the second mapping block group is loaded to the buffer area.

20. The method as set forth in claim 16, wherein
the nonvolatile memory device includes a plurality of memory blocks on a substrate,
each of the memory blocks includes a plurality of memory strings,
each of the memory strings includes at least one memory cell that is located over another memory cell.
